(19) United States
(12) Patent Application Publication
(10) Pub. No.: US 2025/0206625 A1
(43) Pub. Date: Jun. 26, 2025

(54) METHOD OF MAKING MOLECULAR SIEVES OF CON FRAMEWORK TYPE

(71) Applicant: EXXONMOBIL TECHNOLOGY AND ENGINEERING COMPANY, Spring, TX (US)

(72) Inventors: Trong D. PHAM, Flemington, NJ (US); Takayuki IIDA, Iselin, NJ (US); Mary ABDULKARIM, Palisades Park, NJ (US)

(21) Appl. No.: 19/007,179

(22) Filed: Dec. 31, 2024

Related U.S. Application Data
(63) Continuation of application No. PCT/US2023/067629, filed on May 30, 2023.
(60) Provisional application No. 63/359,255, filed on Jul. 8, 2022.

(51) Int. Cl. C01B 39/48

(52) U.S. Cl. CPC C01B 39/48; C01P 2002/72; C01P 2004/03

(57) ABSTRACT

Methods of making molecular sieves of CON framework type using a 1,2,3,4,6,7,8,9-octahydropyridazino[1,2-a]indazol-10-ium cation as structure directing agent are provided, including synthesis mixtures for forming such molecular sieves. Molecular sieve materials obtained by such methods and molecular sieve materials comprising said structure directing agent within their pore structure are also provided.

### CROSS REFERENCE TO RELATED APPLICATIONS

This application is a Continuation of PCT/US2023/067629, filed May 30, 2023, and titled “Method Of Making Molecular Sieves Of Con Framework Type”, which claims the benefit of priority to U.S. Provisional Application No. 63/359,255 filed on Jul. 8, 2022, which is hereby incorporated by reference in its entirety.

### TECHNICAL FIELD

The present disclosure relates to a method of making molecular sieves of CON framework type using a new structure directing agent. The present disclosure also relates to molecular sieve materials obtained by said method and to molecular sieve materials comprising said structure directing agent within their pore structure.

### BACKGROUND OF THE INVENTION

Molecular sieve materials, both natural and synthetic, may be used as adsorbents and have catalytic properties for hydrocarbon conversion reactions. Certain molecular sieves, such as zeolites, AlPOs, and mesoporous materials, are ordered, porous crystalline materials having a definite crystalline structure as determined by X-ray diffraction (XRD). Certain molecular sieves are ordered and produce specific identifiable XRD patterns. Within certain molecular sieve materials there may be a large number of cavities, which may be interconnected by a number of channels or pores. These cavities and pores are uniform in size within a specific molecular sieve material. Because the dimensions of these pores are such as to accept for adsorption molecules of certain dimensions while rejecting those of larger dimensions, these materials have come to be known as “molecular sieves” and are utilized in a variety of industrial processes, e.g., cracking, hydrocracking, disproportionation, alkylation, oligomerization, and isomerization.

Molecular sieves that find application in catalysis and adsorption include any of the naturally occurring or synthetic crystalline molecular sieves. Examples of these molecular sieves include extra-large pore zeolite, large pore zeolites, medium pore size zeolites, and small pore zeolites. These zeolites and their isotypes are classified by the Structure Commission of the International Zeolite Association according to the rules of the IUPAC Commission on Zeolite Nomenclature. According to this classification, framework type zeolites and other crystalline microporous molecular sieves, for which a structure has been established, are assigned a three letter code and are described in the “Atlas of Zeolite Framework Types”, eds. Ch. Baerlocher, L. B. McCusker, and D. H. Olson, Elsevier, Sixth Edition, 2007, which is hereby incorporated by reference. These zeolites and their isotypes are also described in the database of zeolite structures, which provides structural information on all of the Zeolite Framework Types that have been approved by the Structure Commission of the International Zeolite Association (IZA-SC).

The idealized inorganic framework structure of zeolites is a framework of silicate in which all tetrahedral atoms are connected by oxygen atoms with the four next-nearest tetrahedral atoms. The term “silicate”, as used herein, refers to a substance containing at least silicon and oxygen atoms that are alternately bonded to each other (i.e., —O—Si—O—Si—), and optionally including other atoms within the inorganic framework structure, including atoms such as boron, aluminum, or other metals (e.g., transition metals, such as titanium, vanadium, or zinc). Atoms other than silicon and oxygen in the framework silicate occupy a portion of the lattice sites otherwise occupied by silicon atoms in an ‘all-silica’ framework silicate. Thus, the term “framework silicate” as used herein refers to an atomic lattice comprising any of a silicate, borosilicate, gallosilicate, ferrisilicate, aluminosilicate, titanosilicate, zincosilicate, vanadosilicate, or the like.

The structure of the framework silicate within a given zeolite determines the size of the pores or channels that are present therein. The pore or channel size may determine the types of processes for which a given zeolite is applicable. Currently, greater than 200 unique zeolite framework silicate structures are known and recognized by the Structure Commission of the International Zeolite Association, thereby defining a range of pore geometries and orientations.

The framework silicates of zeolites or molecular sieves are commonly characterized in terms of their ring size, wherein the ring size refers to the number of silicon atoms (or alternative atoms, such as those listed above) that are tetrahedrally coordinated with oxygen atoms in a loop to define a pore or channel within the interior of the zeolite. For example, an “8-ring” zeolite refers to a zeolite having pores or channels defined by 8 alternating tetrahedral atoms and 8 oxygen atoms in a loop. The pores or channels defined within a given zeolite may be symmetrical or asymmetrical depending upon various structural constrains that are present in the particular framework silicate.

Zeolites can be classified as having small, medium, large, and extra-large pore structures for pore windows delimited by 8, 10, 12, and more than 12 T-atoms, respectively. Extra-large pore zeolites (>12R) include, for example, AET (14R, e.g., ALPO-8), SFN (14R, e.g., SSZ-59), VFI (18R, e.g., VPI-5), CLO (20R, e.g., cloverite), and ITV (30R, e.g., ITQ-37) framework type zeolites. Extra-large pore zeolites generally have a free pore diameter of larger than about 0.8 nm. Large pore zeolites (12R) include, for example, LTL, MAZ, FAU, EMT, OFF, *BEA, and MOR framework type zeolites, e.g., mazzite, offretite, zeolite L, zeolite Y, zeolite X, omega, ZSM-2, zeolite T, and Beta. Large pore zeolites generally have a free pore diameter of 0.6 to 0.8 nm. Medium (or intermediate) pore size zeolites (10R) include, for example, MFI, MEL, EUO, MTT, MFS, AEL, AFO, HEU, FER, MWW, and TON framework type zeolites, e.g., ZSM-5, ZSM-11, ZSM-22, MCM-22, silicalite-1, and silicalite-2. Medium pore size zeolites generally have a free pore diameter of 0.45 to 0.6 nm. Small pore size zeolites (8R) include, for example, CHA, RTH, ERI, KFI, LEV, and LTA framework type zeolites, e.g., ZK-4, SAPO-34, SAPO-35, ZK-14, SAPO-42, ZK-21, ZK-22, ZK-5, ZK-20, zeolite A, chabazite, and ALPO-17. Small pore size zeolites generally have a free pore diameter of 0.3 to 0.45 nm.

Synthesis of molecular sieve materials typically involves hydrothermal crystallization from a synthesis mixture comprising sources of all the elements present in the molecular sieve (or zeolite) such as sources of silica but also of alumina etc. In many cases a structure directing agent (SDA) is also present. Structure directing agents are compounds which are believed to promote the formation of molecular sieves and which are thought to act as templates around which certain molecular sieve structures can form and which thereby promote the formation of the desired molecular sieve. Various compounds have been used as structure directing agents including various types of quaternary ammonium cations. Typically, molecular sieve (or zeolite) crystals form around structure directing agents with the structure directing agent occupying pores in the molecular sieve once crystallization is complete. The “as-synthesized” (or “as-made”) molecular sieve will therefore contain the structure directing agent in its pores so that, following crystallization, the “as-synthesized” molecular sieve is usually subjected to a treatment step such as a calcination step to remove the structure directing agent.

For instance, large pore zeolites include CON framework type zeolites, such as aluminosilicate SSZ-26, borosilicate SSZ-33, or borosilicate CIT-1, characterized by a three-dimensional pore system composed of intersecting 10- and 12-ring pores. Such large-pore materials with intersecting channels are of high interest for catalytic applications, such as in the petrochemical industry. For instance, U.S. Pat. No. 8,198,501 discloses the use of CON-type zeolites to catalyze the isomerization of light paraffins. It is also believed that such large-pore materials with intersecting channels have increased resistance to fouling and enhanced intracrystalline diffusion properties over materials with unidimensional channels.

SSZ-26 and SSZ-33 materials can be characterized as members of a family of materials in which the two end members are formed by the stacking of layers in an ABAB sequence (“polymorph A”) or an ABCABC sequence (“polymorph B”). In between these end-member polymorphs there is a whole family of materials that can be characterized by a fault probability “p” of 0%<p<100% (“SSZ-26/33 family”). If the fault probability is p=0%, the end member polymorph B is obtained, and if p=100%, the end member polymorph A is obtained. SSZ-26 and SSZ-33 are members of this disorder family of materials. More particularly, SSZ-33 and SSZ-26 are intergrowths of polymorphs A and B with a predominance of polymorph B and a fault probability close to respectively 30% and 15%. SSZ-26 and SSZ-33 materials were first synthesized using respectively a hexamethyl [4.3.3.0]propellane-8,11-diammonium cation or a tricyclo[5.2.1.0^{2,6}]decane quaternary ammonium cation as the structure directing agent (SDA). See, e.g., Lobo et al., “SSZ-26 and SSZ-33: Two Molecular Sieves with Intersecting 10- and 12-Ring Pores” Science, v.262(5139), pp. 1543-1546, Dec. 3, 1993; U.S. Pat. Nos. 4,910,006; 4,963,337; 5,007,997. Zeolites of the SSZ-26/33 family were further synthesized from various SDAs such as 1,5-bis(N,N-dimethylcyclohexylammonium)pentane dications, 1,4-bis(N-cyclohexylpiperidinium)butane dications, 1,4-bis(N-cyclopentylpiperidinium)butane dications, or 1-benzyl-4-aza-1-azoni-abicyclo [2.2.2]octane (See, e.g., U.S. Pat. No. 7,648,694 and 10,730,757) while U.S. Pat. No. 8,647,601 describes the synthesis of SSZ-33 using 1,1′-(pentane-1,5-diyl)bis(3-methylcyclohexyl)piperidinium dications as SDA; U.S. Pat. No. 7,837,978 describes a process for directly preparing aluminum-containing molecular sieve SSZ-26 using a cis-N,N-diethyldecahydroquinolinium cation or mixture of a cis-N,N-diethyldecahydroquinolinium cation and a trans-N,N-diethyldecahydroquinolinium cation as SDA; and U.S. Pat. No. 10,189,717 describes the synthesis of aluminosilicate SSZ-26 by interzeolite transformation from a FAU framework type zeolite in the presence of 1,4-bis(N-cyclohexylpyrrolidinium)butane dications as SDA.

CIT-1 corresponds to pure or nearly pure polymorph B and has been synthesized using N,N,N-trimethyl-(−)-cis-myrtanylammonium hydroxide as SDA. See, e.g., Lobo et al., “CIT-1: A New Molecular Sieve with Intersecting Pores Bounded by 10- and 12-Rings” J. Am. Chem. Soc, v.117, pp. 3766-3779, 1995.

Despite these advances, there remains a need for new structure directing agents and more efficient methods for the synthesis of molecular sieves such as molecular sieves of CON framework type, in particular lower cost alternatives.

According to the present disclosure, it has now been found that the relatively simple cations described herein can be effective as structure directing agents in the synthesis of molecular sieves or zeolites of CON framework type.

### SUMMARY

According to the present disclosure, it has now been found that 1,2,3,4,6,7,8,9-octahydropyridazino[1,2-a]indazol-10-ium cation can suitably be used as a structure directing agent (SDA) for the preparation of molecular sieves (or zeolites) of CON framework type, including for the direct synthesis of aluminium-containing molecular sieves of CON framework type, such as aluminosilicates and aluminoborosilicates. This is especially advantageous as this SDA can be produced in a single step, therefore significantly simplifying the synthesis of CON framework type materials as compared to the processes of the prior art that use more complex SDAs. Also, this SDA allows for the preparation of molecular sieves of CON framework type in the presence of fluoride ions. Making zeolites in the presence of fluoride ions can be advantageous as it may result in less hydrophilic silanol defects (Si—OH) thus higher hydrothermal stability as compared to zeolites prepared by the hydroxide route. Also, higher Si/Al ratios can be obtained in the presence of fluoride ions which could be beneficial when less acidity is required, e.g., in hydroisomerization.

In a first aspect, the present disclosure relates to a method of making a molecular sieve of CON framework type, comprising the following steps: (a) preparing a synthesis mixture comprising water, a source of silica, a source of alumina, a structure directing agent (Q), a mineralizer, and optionally a source of alkali and/or alkaline earth metal element (M), wherein the mineralizer is selected from the group consisting of hydroxide ions (OH), fluoride ions (F), and mixtures thereof, and wherein the structure directing agent (Q) comprises a 1,2,3,4,6,7,8,9-octahydropyridazino[1,2-a]indazol-10-ium cation of Formula 1:

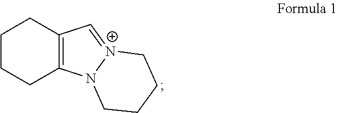 [SMILES: c1c2c(n3[n+]1CCCC3)CCCC2]

(b) heating said synthesis mixture under crystallization conditions including a temperature of from 100° C. to 200° C. for a time sufficient to form crystals of said molecular sieve; and (c) recovering at least a portion of the molecular sieve from step (b).

In a second aspect, the present disclosure relates to a molecular sieve (or zeolite), in particular a molecular sieve (or zeolite) of CON framework type, having at least one 1,2,3,4,6,7,8,9-octahydropyridazino[1,2-a]indazol-10-ium cation of Formula 1 within its pore structure.

In a further aspect, the present disclosure relates to a molecular sieve of CON framework type, obtainable by (or obtained by) the method disclosed herein.

These and other features and attributes of the present disclosure and their advantageous applications and/or uses will be apparent from the detailed description which follows. It will of course be appreciated that features described in relation to one aspect of the present invention may be incorporated into other aspects of the present invention. In particular, any two or more of the features described in this specification, including in this summary section, can be combined to form combinations of features not specifically described herein.

### DESCRIPTION OF THE DRAWINGS

FIG. 1 shows the powder XRD pattern of the as-synthesized material of Example 2.

FIG. 2 shows a SEM image of the as-synthesized product of Example 2.

FIG. 3 shows a SEM image of the as-synthesized product of Example 4.

FIG. 4 shows the powder XRD pattern of the as-synthesized material of Example 11.

FIG. 5 shows the powder XRD pattern of the calcined material of Example 11.

FIG. 6 shows the powder XRD pattern of the as-synthesized material of Example 12.

### DETAILED DESCRIPTION

In a first aspect, the present disclosure relates to a method of making a molecular sieve of CON framework type, comprising the following steps:
(a) preparing a synthesis mixture comprising water, a source of silica, a source of alumina, a structure directing agent (Q), a mineralizer, and optionally a source of alkali and/or alkaline earth metal element (M),
   wherein the mineralizer is selected from the group consisting of hydroxide ions (OH), fluoride ions (F), and mixtures thereof, and
   wherein the structure directing agent (Q) comprises a 1,2,3,4,6,7,8,9-octahydropyridazino[1,2-a]indazol-10-ium cation of Formula 1:

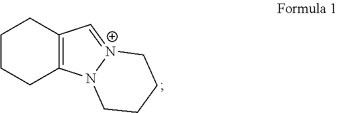 [SMILES: c1c2c(n3[n+]1CCCC3)CCCC2]

(b) heating said synthesis mixture under crystallization conditions including a temperature of from 100° C. to 200° C. for a time sufficient to form crystals of said molecular sieve; and
(c) recovering at least a portion of the molecular sieve from step (b).

The structure directing agent (Q) may be present in any suitable form, for example as a halide, such as a fluoride, a chloride, an iodide or a bromide, as a hydroxide or as a nitrate, for instance in its hydroxide form. The structure directing agent (Q) may be present in the synthesis mixture in a Q/Si molar ratio of 0.01 to 1.0, such as 0.05 to 1.0, or 0.05 to 0.8, or 0.1 to 0.7, for instance 0.05 or 0.1 or 0.15 to 0.5, e.g., 0.15 or 0.2.

The synthesis mixture comprises at least one source of silica. Suitable sources of silica (e.g., silicon oxide sources) include silicates, e.g., tetraalkyl orthosilicates such as tetramethylorthosilicate (TMOS) and tetraethylorthosilicate (TEOS), fumed silica such as Aerosil® (available from Evonik), Cabosperse® (available from Cabot) and Cabosil® (available from DMS), precipitated silica such as Ultrasil® and Sipernat® 340 (available from Evonik), alkali metal silicates such as potassium silicate and sodium silicate, and aqueous colloidal suspensions of silica, for example, that sold by E.I. du Pont de Nemours under the tradename Ludox® or that sold by Evonik under the tradename Aerodisp®; preferably silicates, fumed silica, precipitated silica, alkali metal silicates, and in particular colloidal silica and tetraalkyl orthosilicates such as TEOS.

The synthesis mixture comprises at least one source of alumina. Suitable sources of alumina (e.g., aluminum oxide sources) include aluminum hydroxide, aluminum salts, especially water-soluble salts, such as aluminum sulfate, aluminum nitrate, alkali metal aluminates such as sodium aluminate, and aluminum alkoxides such as aluminum isopropoxide, as well as hydrated aluminum oxides, such as boehmite, gibbsite, and pseudoboehmite, and mixtures thereof. Other aluminum sources include, but are not limited to, other water-soluble aluminum salts, sodium aluminate, aluminum alkoxides, such as aluminum isopropoxide, or aluminum metal, such as aluminum in the form of chips. Especially suitable sources of alumina are aluminum hydroxide and water-soluble salts, such as aluminum sulfate, aluminum nitrate, and alkali metal aluminates such as sodium aluminate and potassium aluminate.

Alternatively or in addition to previously mentioned sources of Si and Al, sources containing both Si and Al elements can also be used. Examples of suitable sources containing both Si and Al elements include amorphous silica-alumina gels or dried silica alumina powders, silica aluminas, clays, such as kaolin, metakaolin, and zeolites, in particular aluminosilicates such as synthetic faujasite and ultrastable faujasite, for instance Ultrastable Y (USY), beta or other large to medium pore molecular sieves or zeolites.

The synthesis mixture may have a Si/Al molar ratio of from 5 to 100, such as 5 to 75, for instance 10 to 50, or 10 to 35, e.g., 10, 15, 20, 25, 30 or 35.

The synthesis mixture may also optionally comprise at least one source of boron oxide, for instance at least one of boric acid and borate salts such as sodium tetraborate or borax and potassium tetraborate. Sources of boron tend to be more soluble than sources of aluminum in hydroxide-mediated synthesis systems. In embodiments wherein the synthesis mixture comprises boron, the molecular sieve is an aluminoborosilicate and boron may be present in the synthesis mixture in a Si/B molar ratio of from 5 to 100, such as 5 to 75, for instance 10 to 50, or 10 to 35, e.g., 10, 15, 20, 25, 30 or 35. In a further embodiment, the synthesis mixture may have a Si/[Al+B] molar ratio of from 5 to 100, such as 5 to 75, for instance 10 to 50, or 10 to 35, e.g., 10, 15, 20, 25, 30 or 35.

The synthesis mixture comprises at least one mineralizer selected from the group consisting of hydroxide ions (OH), fluoride ions (F), and mixtures thereof. The synthesis mixture may comprise the mineralizer in an amount, expressed as (OH+F)/Si molar ratio, of from 0.05 to 1.5, most often from 0.1 to 1.0, such as from 0.15 or 0.2 to 1.0.

When the mineralizer comprises hydroxide ions (OH), the synthesis mixture comprises at least one source of hydroxide ions (OH). For example, hydroxide ions can be present as a counter ion of the structure directing agent (Q) or by the use of aluminum hydroxide or sodium aluminate as a source of alumina. Suitable sources of hydroxide ions can also be selected from the group consisting of alkali metal hydroxides, alkaline earth metal hydroxides, ammonium hydroxide, and mixtures thereof; such as from sodium hydroxide, potassium hydroxide, lithium hydroxide, rubidium hydroxide, calcium hydroxide, magnesium hydroxide, ammonium hydroxide, and mixtures thereof; more often sodium hydroxide, potassium hydroxide, lithium hydroxide, ammonium hydroxide, and mixtures thereof; most often sodium hydroxide and/or potassium hydroxide. The synthesis mixture may comprise the hydroxide ions source in an OH/Si molar ratio of from 0.05 to 1.5, for instance 0.1 to 1.0, such as 0.15 to 0.7, e.g., 0.1 or 0.15 to 0.6 or 0.5. When the mineralizer comprises hydroxide ions (OH), the synthesis mixture may be substantially free from fluoride ions (F).

When the mineralizer comprises fluoride ions (F), the synthesis mixture comprises at least one source of fluoride ions (F). The source of fluoride ions (F) may be any compound capable of releasing fluoride ions in the molecular sieve synthesis mixture. For instance, fluoride ions can be present as a counter ion of the structure directing agent (Q). Non-limiting examples of sources of fluoride ions (F) include hydrogen fluoride (HF); salts containing one or several fluoride ions, such as metal fluoride, preferably where the metal is an alkali or alkaline earth metal such as sodium, potassium, calcium, magnesium, strontium or barium, or a metal such as aluminum (AlF₃, Al₂F₆) or tin (SnF₂); ammonium fluoride (NH₄F); and ammonium bifluoride (NH₄HF₂). Especially convenient sources of fluoride ions are HF, NH₄F, and NH₄HF₂, in particular HF. Small amounts of fluoride ions (F) may also be present as impurities, for instance in the optional source of alkali or alkaline earth metal cation (M). The fluoride ions (F) may be present in a F/Si molar ratio of 0.05 to 1.5, for instance 0.1 to 1.0, such as 0.15 to 0.7, e.g., 0.1 to 0.15 to 0.6 or 0.5. When the mineralizer comprises fluoride ions (F), the synthesis mixture may further comprise hydroxide ions (OH) or may be substantially free from hydroxide ions (OH), preferably it further comprises hydroxide ions (OH).

Optionally, the synthesis mixture may comprise one or more sources of alkali or alkaline earth metal cation (M). If present, M is preferably selected from the group consisting of sodium, potassium, lithium, rubidium, calcium, magnesium, strontium, barium, and mixtures thereof, preferably sodium and/or potassium. The sodium source, when present, may be sodium hydroxide, sodium aluminate, sodium silicate, sodium aluminate or sodium salts such as NaCl, NaBr or sodium nitrate. The potassium source, when present, may be potassium hydroxide, potassium aluminate, potassium silicate, a potassium salt such as KCl or KBr or potassium nitrate. The lithium source, when present, may be lithium hydroxide or lithium salts such as LiCl, LiBr, LiI, lithium nitrate, or lithium sulfate. The rubidium source, when present, may be rubidium hydroxide or rubidium salts such as RbCl, RbBr, RbI, or rubidium nitrate. The calcium source, when present, may be calcium hydroxide. The magnesium source, when present, may be magnesium hydroxide. The strontium source, when present, may be strontium hydroxide. The barium source, when present, may be barium hydroxide. The alkali or alkaline earth metal cation M may also be present in the one or more sources of alumina or boron oxide, such as sodium aluminate, sodium tetraborate, potassium tetraborate, and/or in the one or more sources of silica, such as potassium silicate and/or sodium silicate. The source of alkali or alkaline earth metal cation (M) is advantageously soluble in water. The synthesis mixture may comprise the alkali or alkaline earth metal cation (M) source in a M/Si molar ratio of 0 to 1.0, such as, when M is present, 0.01 to 0.5, in particular 0.05 to 0.5, e.g., 0.05 to 0.2. Alternatively, the synthesis mixture may be substantially free from alkali or alkaline earth metal cation (M). More particularly, in the first embodiment described above, the synthesis mixture may comprise the alkali or alkaline earth metal cation (M) source in a M/Si molar ratio of 0.01 to 1.0, such as 0.01 or 0.05 to 0.5, e.g., 0.05 or 0.1 to 0.2 or 0.15 while in the second or third embodiments described above, the synthesis mixture may either comprise the alkali or alkaline earth metal cation (M) source in such amounts or more often be substantially free from alkali or alkaline earth metal cation (M).

The synthesis may be performed with our without added nucleating seeds. If nucleating seeds are added to the synthesis mixture, the seeds may be of the same or of a different framework type than the molecular sieve obtained by the present method, for instance molecular sieves obtained from a different or from a previous synthesis, and may suitably present in an amount from about 0.01 ppm by weight to about 10,000 ppm by weight, based on the synthesis mixture, such as from about 100 ppm by weight to about 5,000 ppm by weight of the synthesis mixture.

The synthesis mixture typically comprises water in a H₂O/Si molar ratio of from 1 to 100, such as 4 or 5 to 80 or 70 or 50, for instance 4 or 5 to 30 or 20. More particularly, in the first embodiment described above, the synthesis mixture may comprise water in a H₂O/Si molar ratio of 1 to 100, such as 4 to 80 or 5 to 70, such as 10 to 80 or 20 to 70, e.g., 20, 25 or 30, while in the second or third embodiments described above, the synthesis mixture may comprise water in a H₂O/Si molar ratio of 1 to 100, such as 2 to 50 or 3 to 30, such as 3 to 20 or 4 to 15, e.g., 4 to 10. Depending on the nature of the components in the base mixture, the amount of solvent (e.g., water from the hydroxide solution, and optionally methanol and ethanol from the hydrolysis of silica sources) of the base mixture may be removed such that a desired solvent to Si molar ratio is achieved for the synthesis mixture. Suitable methods for reducing the solvent content may include evaporation under a static or flowing atmosphere such as ambient air, dry nitrogen, dry air, or by spray drying or freeze drying. Water may also be added to the resulting mixture to achieve the desired H₂O/Si molar ratio when too much water is removed during the solvent removal process. In some examples, water removal is not necessary when the preparation have sufficient H₂O/Si molar ratio.

Carbon in the form of CH₂ may be present in the various sources of components used to prepare the synthesis mixture of the present disclosure, e.g., silica source or trivalent element source, and incorporated into the resulting molecular sieve framework as bridging atoms. Nitrogen atoms may be incorporated into the framework of the molecular sieve material as bridging atoms after the SDA has been removed.

In one or more aspects, the synthesis mixture after solvent adjustment (e.g., where the desired water to silica ratio is achieved) may be mixed by a mechanical process such as stirring or high shear blending to assure suitable homogenization of the base mixture, for example, using dual asymmetric centrifugal mixing (e.g., a FlackTek speedmixer) with a mixing speed of 1000 rpm to 3000 rpm (e.g., 2000 rpm).

The synthesis mixture is then subject to crystallization conditions suitable for the molecular sieve material to form. Crystallization of the molecular sieve material may be carried out under static or stirred conditions in a suitable reactor vessel, such as for example, Teflon® lined or stainless steel autoclaves placed in a convection oven maintained at an appropriate temperature.

The crystallization in step (b) of the method is typically carried out at a temperature of 100° C. to 200° C., such as 120° C. to 180° C., e.g., 160° C. or 170° C., for a time sufficient for crystallization to occur at the temperature used. For instance, at higher temperatures, the crystallization time may be reduced. For instance, the crystallization conditions in step (b) of the method may include heating for a period of from 1 to 100 days, such as from 1 to 50 days, for example from 1 to 30 days, e.g., at least 1 or at least 5 days up to 30 or 20 days. The crystallization time can be established by methods known in the art such as by sampling the synthesis mixture at various times and determining the yield and X-ray crystallinity of precipitated solid. Unless indicated otherwise herein, the temperature measured is the temperature of the surrounding environment of the material being heated, for example the temperature of the atmosphere in which the material is heated.

Typically, the molecular sieve is formed in solution and can be recovered by standard means, such as by centrifugation or filtration. The separated molecular sieve can also be washed, recovered by centrifugation or filtration and dried.

The molecular sieve of the present disclosure, when employed either as an adsorbent or as a catalyst in an organic compound conversion process may be dehydrated (e.g., dried) at least partially. This can be done by heating to a temperature in the range of 80° C. to 500° C., such as 90° C. to 370° C. in an atmosphere such as air, nitrogen, etc., and at atmospheric, subatmospheric or superatmospheric pressures for between 30 minutes and 48 hours. Dehydration may also be performed at room temperature merely by placing the molecular sieve in a vacuum, but a longer time is required to obtain a sufficient amount of dehydration.

As a result of the crystallization process, the recovered product contains within its pores at least a portion of the structure directing agent used in the synthesis. The as-synthesized molecular sieve recovered from step (c) may thus be subjected to thermal treatment or other treatment to remove part or all of the SDA incorporated into its pores during the synthesis. Thermal treatment (e.g., calcination) of the as-synthesized molecular sieve typically exposes the materials to high temperatures sufficient to remove part or all of the SDA, in an atmosphere selected from air, nitrogen, ozone or a mixture thereof in a furnace. While subatmospheric pressure may be employed for the thermal treatment, atmospheric pressure is desired for reasons of convenience. The thermal treatment may be performed at a temperature up to 925° C. e.g., 300° C. to 700° C. or 400° C. to 600° C. The temperature measured is the temperature of the surrounding environment of the sample. The thermal treatment (e.g., calcination) may be carried out in a box furnace in dry air, which has been exposed to a drying tube containing drying agents that remove water from the air. The heating is usually calcined for at least 1 minute and generally no longer than 1 or at most a few days. The heating may first be carried out under a nitrogen atmosphere and then the atmosphere may be switched to air and/or ozone.

The molecular sieve may also be subjected to an ion-exchange treatment, for example, with aqueous ammonium salts, such as ammonium nitrates, ammonium chlorides, and ammonium acetates, in order to remove remaining alkali metal cations and/or alkaline earth metal cations, if present in the synthesis mixture, and to replace them with protons thereby producing the acid form of the molecular sieve. To the extent desired, the original cations of the as-synthesized material, such as alkali metal cations, can be replaced by ion exchange with other cations. Preferred replacing cations can include hydrogen ions, hydrogen precursor, e.g., ammonium ions and mixtures thereof. The ion exchange step may take place after the as-made molecular sieve is dried. The ion-exchange step may take place either before or after a calcination step.

The molecular sieve may also be subjected to other treatments such as steaming and/or washing with solvent. Such treatments are well-known to the skilled person and are carried out in order to modify the properties of the molecular sieve as desired.

In second aspect, the present disclosure relates to a molecular sieve, more particularly a molecular sieve of CON framework type, having at least one 1,2,3,4,6,7,8,9-octahydropyridazino[1,2-a]indazol-10-ium cation of Formula 1 within its pore structure

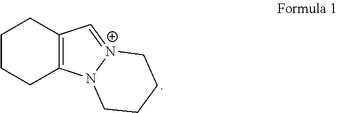 [SMILES: c1c2c(n3[n+]1CCCC3)CCCC2]

Said molecular sieve may be an aluminosilicate or an aluminoborosilicate and may be represented by the molecular formula of Formula 2:

(q)Q:(m)Al₂O₃:(n)B₂O₃:SiO₂ (Formula 2),

wherein 0<q≤1.0, 0.005<m≤0.1, O≤n≤0.1, and Q is a 1,2,3,4,6,7,8,9-octahydropyridazino[1,2-a]indazol-10-ium cation of Formula 1. The oxygen atoms in Formula 2 may be replaced by carbon atoms (e.g. in the form of CH₂), which can come from sources of the components used to prepare the as-made molecular sieve. The oxygen atoms in Formula 2 can also be replaced by nitrogen atoms, e.g., after the SDA has been removed. Formula 2 can represent the framework of a typical molecular sieve having structure directing agent (Q) within its pore structure and is not meant to be the sole representation of such material. The molecular sieve material may contain impurities which are not accounted for in Formula 2. Further, Formula 2 does not include the protons and charge compensating ions that may be present in the molecular sieve material.

The variable m represents the molar ratio relationship of Al₂O₃ to SiO₂ in Formula 2. For example, when m is 0.005, the molar ratio of SiO₂ to Al₂O₃ is 200 and the Si/Al molar ratio is 100. m may vary from 0.005 to 0.1, such as from 0.007 to 0.1, e.g., from 0.01 to 0.05 or from 0.015 to 0.05. The molar ratio of Si to Al may be 5 to 100, in particular 5 to 75, such as 10 to 50, for instance 10 to 35.

The variable n represents the molar ratio relationship of B₂O₃ to SiO₂ in Formula 2. When n is 0, boron is absent and the molecular sieve is an aluminosilicate. When n is greater than 0, boron is present and the molecular sieve is an aluminoborosilicate. For example, when n is 0.005, the molar ratio of SiO₂ to B₂O₃ is 200 and the Si/B molar ratio is 100. When boron is present, n may vary from 0.005 to 0.1, such as from 0.007 to 0.1, e.g., from 0.01 to 0.05, or from 0.015 to 0.05. When boron is present, the molar ratio of Si to B may be 5 to 100, in particular 5 to 75, such as 10 to 50, for instance 10 to 35.

The variable q represents the molar relationship of Q to SiO₂ in Formula 2. For example, when n is 0.1, the Q/Si molar ratio is 0.1. The molar ratio of Q to SiO₂ may be from 0 to 1.0, such as from 0.01 to 0.8 or 0.02 to 0.7, e.g., 0.1 to 0.5.

In a further aspect, the present disclosure relates to a molecular sieve of CON framework type, obtainable by (or obtained by) the method disclosed herein.

Said molecular sieve material, in particular when prepared in the presence of hydroxide ions, may have, in its as-synthesized form (e.g., where the SDA has not been removed) and/or in its calcined form (e.g., where at least part of the SDA has been removed), X-ray diffraction patterns similar to those of SSZ-26 zeolite (comprising about 15% polymorph A), as disclosed in respectively Tables 3 and 5 of U.S. Pat. No. 10,730,757 which is incorporated herein by reference in its entirety. When prepared in the presence of fluoride ions, said molecular sieve material may have, in its as-synthesized form (e.g., where the SDA has not been removed) and/or in its calcined form (e.g., where at least part of the SDA has been removed), X-ray diffraction patterns similar to those of SSZ-33 zeolite (comprising about 30% polymorph A), as disclosed in respectively Tables 1(a) and 1(b) of U.S. Pat. No. 4,963,337 which is incorporated herein by reference in its entirety.

It will be understood by a person skilled in the art that the molecular sieve obtainable by the method disclosed herein may contain impurities, such as amorphous materials, unit cells having different topologies (e.g., quartz or molecular sieves of different framework type, that may or may not impact the performance of the resulting catalyst), and/or other impurities (e.g., heavy metals and/or organic hydrocarbons). Typical examples of molecular sieves of different framework type co-existing with the molecular sieve of the present disclosure are e.g., molecular sieves of MTW, BEA, FAU, or MOR framework type, such as ZSM-12, zeolite beta, undissolved faujasite, or mordenite. The molecular sieve of the present disclosure is preferably substantially free of impurities. The term “substantially free of impurities” (or in the alternative “substantially pure”) used herein means the molecular sieve material contains a minor proportion (less than 50 wt %), preferably less than 20 wt %, more preferably less than 10 wt %, even more preferably less than 5 wt % and most preferably less than 1 wt % (e.g., less than 0.5 wt % or 0.1 wt %), of such impurities (or “non-CON“framework type” material), which weight percent (wt %) values are based on the combined weight of impurities and pure molecular sieve. The amount of impurities can be appropriately determined by powder XRD, rotating electron diffraction, and/or SEM/TEM (e.g., different crystal morphologies).

The molecular sieve obtainable by the method described herein is substantially crystalline. As used herein, the term “crystalline” refers to a crystalline solid form of a material, including, but not limited to, a single-component or multiple-component crystal form, e.g., including solvates, hydrates, and a co-crystal. Crystalline can mean having a regularly repeating and/or ordered arrangement of molecules, and possessing a distinguishable crystal lattice. For example, the molecular sieve can have different water or solvent content. The different crystalline lattices can be identified by solid state characterization methods such as by XRD (e.g., powder XRD). Other characterization methods known to a person of ordinary skill in the relevant art can further help identify the crystalline form as well as help determine stability and solvent/water content. As used herein, the term “substantially crystalline” means a majority (greater than 50 wt %) of the weight of a sample of a material described is crystalline and the remainder of the sample is a non-crystalline form. In one or more aspects, a substantially crystalline sample has at least 95% crystallinity (e.g., 5% of the non-crystalline form), at least 96% crystallinity (e.g., 4% of the non-crystalline form), at least 97% crystallinity (e.g., 3% of the non-crystalline form), at least 98% crystallinity (e.g., about 2% of the non-crystalline form), at least 99% crystallinity (e.g., 1% of the non-crystalline form), and 100% crystallinity (e.g., 0% of the non-crystalline form).

Aspects of the disclosure are described in greater detail by way of specific examples. The following examples are offered for illustrative purposes, and are not intended to limit the disclosure in any manner. Those of skill in the relevant art will readily recognize a variety of parameters can be changed or modified to yield essentially the same results.

### Examples

The present disclosure is further illustrated below without limiting the scope thereto.

In these examples, the X-ray diffraction (XRD) patterns of the as-synthesized and calcined materials were recorded on an X-Ray Powder Diffractometer (Bruker DaVinci D8 Discovery instrument) in continuous mode using a Cu Kα radiation, Bragg-Bentano geometry with Vantec 500 detector, in the 2θ range of 4 to 36 degrees. The interplanar spacings, d-spacings, were calculated in Angstrom units, and the relative intensities of the lines, I/I_{O} is the ratio of the peak intensity to that of the intensity of the strongest line, above background. The intensities are uncorrected for Lorentz and polarization effects. The location of the diffraction peaks in 2-theta, and the relative peak area intensities of the lines, I/I(o), where Io is the intensity of the strongest line, above background, were determined with the MDI Jade peak search algorithm. It should be understood that diffraction data listed as single lines may consist of multiple overlapping lines which under certain conditions, such as differences in crystallographic changes, may appear as resolved or partially resolved lines. Typically, crystallographic changes can include minor changes in unit cell parameters and/or a change in crystal symmetry, without a change in the framework connectivity. These minor effects, including changes in relative intensities, can also occur as a result of differences in cation content, framework composition, nature and degree of pore filling, crystal size and shape, preferred orientation and thermal and/or hydrothermal history.

The scanning electron microscopy (SEM) images of the as-synthesized materials were obtained on a Hitachi 4800 Scanning Electron Microscope. SEM images were used to aid assessment of product purity. The presence of obviously different crystal morphologies in a SEM image can be an indication of impurities in the form of other crystalline materials. Such an approximate analysis can be especially useful in identifying the presence of formation of relatively minor amounts of crystalline impurities which may not be identifiable on product XRD patterns.

The following measurements were conducted on samples that were ion-exchanged (when an alkali metal was present in the synthesis mixture) and calcined. For each sample subjected to ion-exchange and calcination, the procedure used was as follows: the as-prepared sample was calcined at 560° C. for 8 hours to remove the SDA, then ion-exchanged two times with a 1M ammonium nitrate solution, and then calcined at 500° C. for 4 hours.

The overall BET surface area (S_{BET}) of the materials was determined by the BET method as described by S. Brunauer, P. H. Emmett and E. Teller, J. Am. Chem. Soc., 1938, v.60, pg. 309, incorporated herein by reference, using nitrogen adsorption-desorption at liquid nitrogen temperature. The external surface area (Sext) of the material was obtained from the t-plot method.

The micropore volume (V_{micro}) of the materials can be determined using methods known in the relevant art. For example, the micropore volume of the materials can be measured with nitrogen physisorption, and the data can be analyzed by the t-plot method described in Lippens, B. C. et al., “Studies on pore system in catalysts: V. The t method”, J. Catal., v.4, pg. 319 (1965), which describes micropore volume method and is incorporated herein by reference.

Alpha value is a measure of the cracking activity of a catalyst and is described in U.S. Pat. No. 3,354,078 and in the Journal of Catalysis, v.4, pg. 527 (1965); v.6, pg. 278 (1966); and v.61, pg. 395 (1980), each incorporated herein by reference as to that description. The experimental conditions of the test used herein include a constant temperature of 538° C. and a variable flow rate as described in detail in the Journal of Catalysis, v.61, pg. 395.

### Example 1: Synthesis of 1,2,3,4,6,7,8,9-octahydropyridazino[1,2-a]indazol-10-ium hydroxide

45 g K₂CO₃ were added to a solution of 20 g 4,5,6,7-tetrahydroindazole in acetonitrile (250 mL). After stirring for 30 minutes at ambient temperature, 70 g 1,4-dibromobutane was added. The reaction mixture was stirred at ambient temperature for about 4 hours, and then the temperature was increased to 90° C. for about 24 hours. The mixture was subsequently allowed to cool to ambient temperature, and the solvent was evaporated under reduced pressure. The residue was taken up in dichloromethane and the resulting suspension was filtered. The solvent was removed in vacuo to yield solid corresponding to 1,2,3,4,6,7,8,9-octahydropyridazino[1,2-a]indazol-10-ium bromide.

The vacuum-dried bromide salt was then ion-exchanged with ion-exchange resin Amberlite® IRN78 OH hydroxide form with a bromide:resin:water weight ratio of 1:3.5:5, to the hydroxide form. The exchange was performed at room temperature overnight.

The molar ratios and conditions used for the syntheses of Examples 2-13 are detailed below and summarized in Table 2.

### Example 2: Synthesis of Molecular Sieve of CON Framework Type from USY Zeolite in the Presence of NaOH_(Si/Al=15)

In a PTFE liner for a 23 mL Steel Parr autoclave, the following were mixed together: 1.90 g SDAOH solution (13.9 wt %), 1.35 g sodium hydroxide (NaOH, 4 wt %), 1.10 g deionized water, and 0.64 g Ultrastable Y (USY) zeolite with a Si/Al molar ratio of 15 (available from Zeolyst as CBV720), to produce a synthesis mixture having the following composition in terms of molar ratios:

25 H₂O:1 SiO₂:0.033 Al₂O₃:0.15 SDAOH: 0.15 NaOH.

The liner was then capped, sealed within a 23 mL Parr autoclave, and placed within a spit inside of a convection oven. The reactor was heated at 160° C. for 10 days under tumbling conditions (about 30 rpm). The as-synthesized material was isolated by filtration, rinsed with deionized water and dried at 90° C. in a vented drying oven.

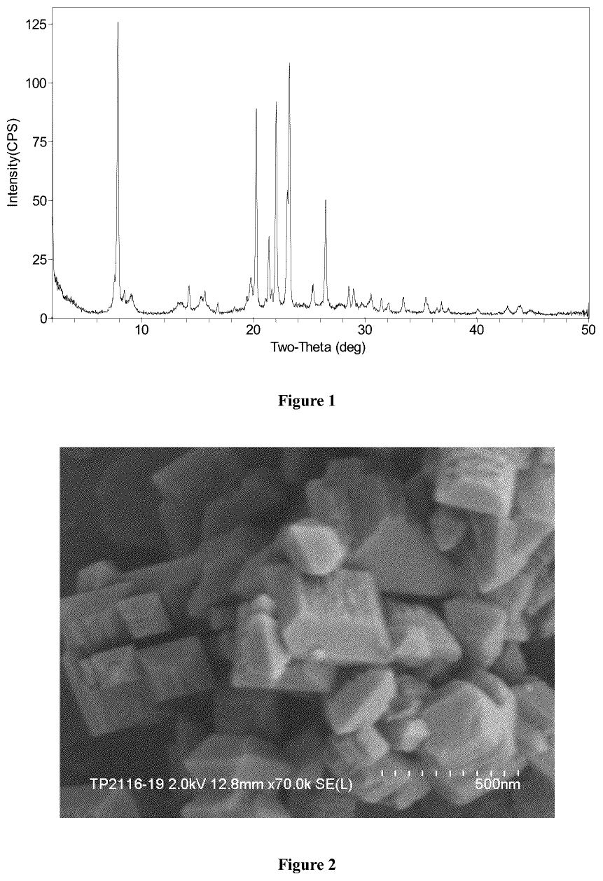

XRD analysis of the as-synthesized product showed the material to have a CON framework type. FIG. 1 shows the powder XRD pattern of the as-synthesized material. FIG. 2 shows a SEM image of the as-synthesized material.

XRF analysis of the calcined and ion-exchanged material indicated the zeolite product had a Si/Al molar ratio of 21.

The BET specific surface area (S_{BET}) of the ion-exchanged and calcined material was 609 m²/g, its external surface area (Sext) was 92 m²/g, its micropore volume (V_{micro}) was 0.22 cc/g, and its Alpha Value was 1600. The observed micropore volume and specific surface area (S_{BET}) are in line with values reported for zeolites of CON framework type which also shows that the current structure directing agent was able to drive to full crystallization. [0073]n-hexane, 2,2-dimethylbutane (2,2-DMB), and 2,3-dimethylbutane (2,3-DMB), uptakes were determined on ion-exchanged and calcined materials. The material was placed under a nitrogen stream then the hydrocarbon was introduced through a sparger to saturate the nitrogen stream and the hydrocarbon uptake was determined. Each hydrocarbon was adsorbed at a different temperature: n-hexane was adsorbed at 90° C., 2,2-DMB was adsorbed at 120° C., and 2,3-DMB was adsorbed at 120° C. n-hexane uptake was 133 mg/g, 2,2-DMB uptake was 141 mg/g, and 2,3-DMB uptake was 142 mg/g.

### Example 3: Synthesis of Molecular Sieve of CON Framework Type from Silica and USY Zeolite in the Presence of NaOH (Si/Al=16)

This Example was conducted in similar conditions as Example 2 except that silica was used combination with an USY zeolite in the presence of a higher amount of water. In a PTFE liner for a 23 mL Steel Parr autoclave, the following were mixed together: 2.17 g SDAOH solution (13.9 wt %), 0.52 g Cab-O-Sil® M5 (medium surface fused silica available from Spectrum Chemical), 1.54 g sodium hydroxide (NaOH, 4 wt %), 2.16 g deionized water, and 0.19 g Ultrastable Y (USY) zeolite with a Si/Al molar ratio of 2.5 (available from Zeolyst as CBV500), to produce a synthesis mixture having the following composition in terms of molar ratios:

30 H₂O:1 SiO₂:0.031 Al₂O₃:0.15 SDAOH: 0.15 NaOH.

The liner was then capped, sealed within a 23 mL Parr autoclave, and placed within a spit inside of a convection oven. The reactor was heated at 160° C. for 18 days under tumbling conditions (about 30 rpm). The as-synthesized material was isolated by filtration, rinsed with deionized water and dried at 90° C. in a vented drying oven.

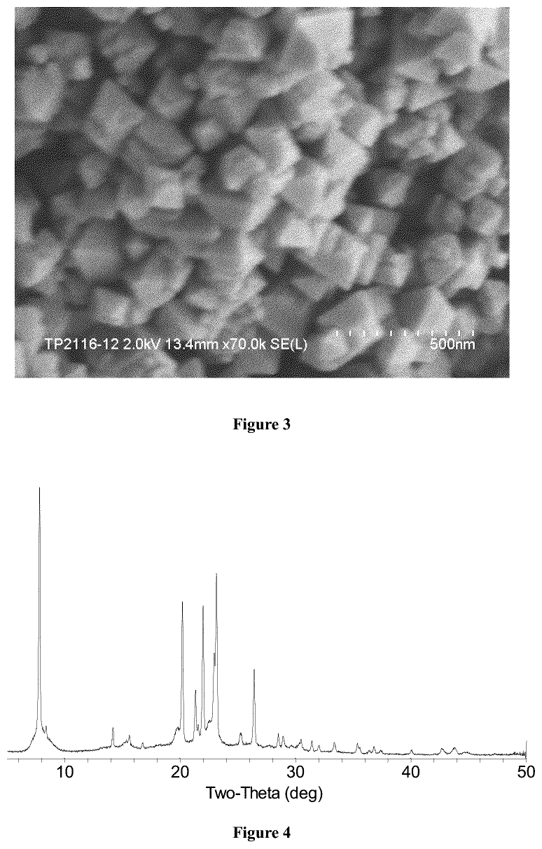

This material had a XRD pattern similar to the XRD pattern of the as-synthesized material of Example 2. FIG. 3 shows a SEM image of the as-synthesized material.

### Example 4: Synthesis of CON Molecular Sieve from Silica and USY Zeolite in the Presence of NaOH (Si/Al=16)

This Example was conducted in similar conditions as Example 4 except that the synthesis mixture contained a lower amount of NaOH and a higher amount of SDAOH, to produce a synthesis mixture having the following composition in terms of molar ratios:

30 H₂O:1 SiO₂:0.031 Al₂O₃:0.2 SDAOH: 0.1 NaOH.

After 18 days of heating at 160° C., a molecular sieve of CON framework type, having a XRD pattern similar to the XRD pattern of the as-synthesized material of Example 2 was obtained.

### Example 5: Synthesis of Molecular Sieve of CON Framework Type from Colloidal Silica and Sodium Aluminate in the Presence of NaOH (Si/Al=25)

This Example was conducted in similar conditions as the former examples but from a synthesis mixture containing Ludox® HS40 (40 wt % colloidal silica suspension) as source of Si and sodium aluminate (NaAlO₂, 25 wt % Al₂O₃, 19.3 wt % Na₂O) as source of Al. The synthesis mixture had the following composition in terms of molar ratios:

25 H₂O:1 SiO₂:0.02 Al₂O₃:0.15 SDAOH: 0.1 NaOH.

After 18 days of heating at 160° C., a molecular sieve of CON framework type, having a XRD pattern similar to the XRD pattern of the as-synthesized material of Example 2 was obtained.

### Example 6: Synthesis of Molecular Sieve of CON Framework Type from Colloidal Silica and Sodium Aluminate in the Presence of NaOH (Si/Al=20)

This Example was conducted in similar conditions as Example 6 but from a synthesis mixture having slightly different molar ratios:

30 H₂O 1 SiO₂:0.02 Al₂O₃:0.2 SDAOH: 0.1 NaOH.

After 18 days of heating at 160° C., a molecular sieve of CON framework type, having a XRD pattern similar to the XRD pattern of the as-synthesized material of Example 2 was obtained.

### Example 7: Synthesis of Molecular Sieve of CON Framework Type from Colloidal Silica and Aluminum Hydroxide in the Presence of KOH (Si/Al=16)

This Example was conducted in similar conditions as the former Examples but from a synthesis mixture comprising Ludox® HS40 (40 wt % colloidal silica suspension) as source of Si, aluminum hydroxide (Al(OH)₃, Sigma 54 wt % Al₂O₃) as source of Al, and potassium hydroxide (KOH, 20 wt %). The synthesis mixture had the following composition in terms of molar ratios: 30 H₂O: 1 SiO₂: 0.031 Al₂O₃: 0.15 SDAOH: 0.15 KOH.

After 18 days of heating at 160° C., a molecular sieve of CON framework type, having a XRD pattern similar to the XRD pattern of the as-synthesized material of Example 2 was obtained.

### Example 8: Synthesis of Molecular Sieve of CON Framework Type from Colloidal Silica and Aluminum Hydroxide in the Presence of KOH (Si/Al=15)

This Example was conducted in similar conditions as Example 7, but from a synthesis mixture having the following composition in terms of molar ratios: 25 H₂O: 1 SiO₂: 0.033 Al₂O₃: 0.15 SDAOH: 0.15 KOH.

After 10 days of heating at 170° C., a molecular sieve of CON framework type, having a XRD pattern similar to the XRD pattern of the as-synthesized material of Example 2 was obtained.

### Example 9: Synthesis of Molecular Sieve of CON Framework Type from Colloidal Silica and Aluminum Hydroxide in the Presence of KOH (Si/Al=10)

This Example was conducted in similar conditions as Example 9 but from a synthesis mixture containing a higher amount of Al. The synthesis mixture had the following composition in terms of molar ratios:

25 H₂O:1 SiO₂:0.05 Al₂O₃:0.15 SDAOH: 0.15 KOH.

After 10 days of heating at 170° C., a molecular sieve of CON framework type, having a XRD pattern similar to the XRD pattern of the as-synthesized material of Example 2 was obtained.

### Example 10: Synthesis of Molecular Sieve of CON Framework Type from TEOS and Aluminum Hydroxide in the Presence of HF (Si/Al=33)

In a PTFE liner for a 23 mL Steel Parr autoclave, 4.75 g SDAOH solution (13.9 wt %), 1.41 g tetraethylorthosilicate (TEOS, >99 wt %), and 0.019 g aluminum hydroxide (Al(OH)₃, 54% wt Sigma) were stirred at room temperature for 3 hours, then the temperature was raised to 60° C. to remove 1.24 g ethanol and 3.45 g H₂O. Finally, 0.14 g HF (48 wt % solution) was added to the gel to produce a synthesis mixture having the following composition in terms of molar ratios:

4 H₂O:1 SiO₂:0.015 Al₂O₃:0.5 SDAOH: 0.5 HF.

The liner was then capped, sealed within a 23 mL Parr autoclave, placed within a spit inside of a convection oven, and heated at 160° C. for 16 days under tumbling conditions (about 30 rpm). The resulting as-synthesized material was identified as a molecular sieve of CON framework type, having a XRD pattern similar to the XRD pattern of the as-synthesized material of Example 2, plus a minor amount impurity phase identified as zeolite beta.

### Example 11: Synthesis of Molecular Sieve of CON Framework Type from TEOS and Aluminum Hydroxide in the Presence of HF (Si/Al=17)

This Example was conducted in similar conditions as Example 11 but from a synthesis mixture containing a higher amount of Al. The synthesis mixture had the following composition in terms of molar ratios:

4 H₂O:1 SiO₂:0.029 Al₂O₃:0.5 SDAOH: 0.5 HF.

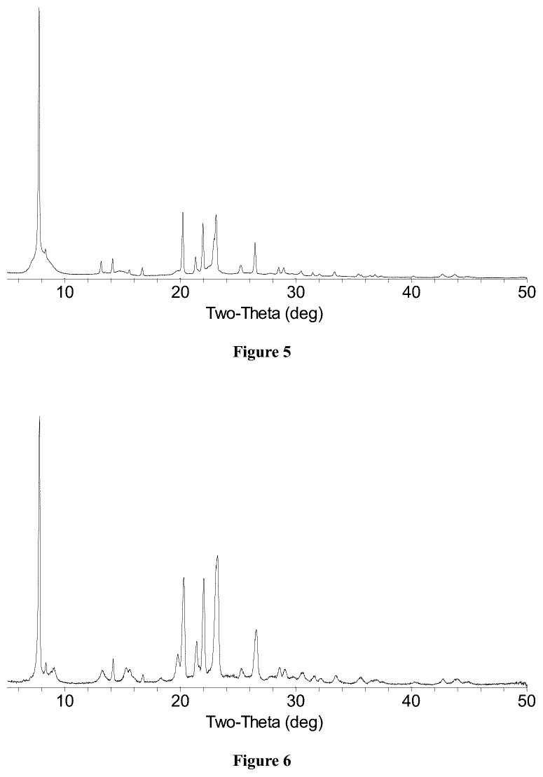

After 9 days of heating at 160° C. XRD analysis of the as-synthesized and calcined products, as illustrated by FIGS. 4 and 5, showed the material to have a CON framework type.

### Example 12: Synthesis of a Molecular Sieve of CON Framework Type from USY Zeolite and Boric Acid in the Presence of KOH (Si/Al=30, Si/B=20)

In a PTFE liner for a 23 mL Steel Parr autoclave, the following were mixed together: 1.98 g SDAOH solution (9.8 wt %), 0.36 g potassium hydroxide (KOH, 20 wt %), 1.9 g deionized water, 0.69 g H₃BO₃ (3.9 wt %), and 0.54 g Ultrastable Y (USY) zeolite with a Si/Al molar ratio of 30 (available from Zeolyst as CBV760), to produce a synthesis mixture having the following composition in terms of molar ratios:

30 H₂O:1 SiO₂:0.0167 Al₂O₃:0.025 B₂O₃: 0.15 SDAOH: 0.15 KOH.

The liner was then capped, sealed within a 23 mL Parr autoclave, and placed within a spit inside of a convection oven. The reactor was heated at 170° C. for 12 days under tumbling conditions (about 30 rpm). The as-synthesized material was isolated by filtration, rinsed with deionized water and dried at 90° C. in a vented drying oven. XRD analysis of the as-synthesized product, as illustrated by FIG. 6, showed the material to have a CON framework type.

### Example 13: Synthesis of a Molecular Sieve of CON Framework Type from USY Zeolite and Boric Acid in the Presence of KOH (Si/Al=30, Si/B=33)

In a PTFE liner for a 23 mL Steel Parr autoclave, the following were mixed together: 1.98 g SDAOH solution (9.8 wt %), 0.36 g potasium hydroxide (KOH, 20 wt %), 2.16 g deionized water, 0.41 g H₃BO₃ (3.9 wt %), and 0.54 g Ultrastable Y (USY) zeolite with a Si/Al molar ratio of 30 (available from Zeolyst as CBV760), to produce a synthesis mixture having the following composition in terms of molar ratios:

30 H₂O:1 SiO₂:0.0167 Al₂O₃:0.015 B₂O₃: 0.15 SDAOH: 0.15 KOH.

The liner was then capped, sealed within a 23 mL Parr autoclave, and placed within a spit inside of a convection oven. The reactor was heated at 170° C. for 12 days under tumbling conditions (about 30 rpm). The as-synthesized material was isolated by filtration, rinsed with deionized water and dried at 90° C. in a vented drying oven. The resulting as-synthesized material was identified as a molecular sieve of CON framework type, having a XRD pattern similar to the XRD pattern of the as-synthesized material of Example 12.

TABLE 2

| | Si | Al | B | Si/ | Si/ | H₂O/ | SDA/ | OH/ | | | T | T |
|---|---|---|---|---|---|---|---|---|---|---|---|---|
| Ex. | Source | Source | Source | Al | B | Si | Si | Si | M/Si | F/Si | (° C.) | (days) |
| 2 | CBV720 | CBV720 | — | 15 | — | 25 | 0.15 | 0.3 | 0.15 | — | 160 | 10 |
| | | | | | | | | | (Na) | | | |
| 3 | Cabosil | CBV500 | — | 16 | — | 30 | 0.15 | 0.3 | 0.15 | — | 160 | 18 |
| | M5 | CBV500 | | | | | | | (Na) | | | |
| 4 | Cabosil | CBV500 | — | 16 | — | 30 | 0.2 | 0.3 | 0.1 | — | 160 | 18 |
| | M5 | | | | | | | | (Na) | | | |
| 5 | Ludox | NaAlO₂ | — | 25 | — | 25 | 0.15 | 0.25 | 0.1 | — | 160 | 18 |
| | | | | | | | | | (Na) | | | |
| 6 | Ludox | NaAlO₂ | — | 20 | — | 30 | 0.2 | 0.3 | 0.1 | — | 160 | 18 |
| | | | | | | | | | (Na) | | | |
| 7 | Ludox | Al(OH)₃ | — | 16 | — | 30 | 0.15 | 0.3 | 0.15 | — | 160 | 18 |
| | Ludox | | | | | | | | (K) | | | |
| 8 | Ludox | Al(OH)₃ | — | 15 | — | 25 | 0.15 | 0.3 | 0.15 | — | 170 | 10 |
| | | | | | | | | | (K) | | | |
| 9 | Ludox | Al(OH)₃ | — | 10 | — | 25 | 0.15 | 0.3 | 0.15 | — | 170 | 10 |
| | | | | | | | | | (K) | | | |
| 10 | TEOS | Al(OH)₃ | — | 33 | — | 4 | 0.5 | 0.5 | 0 | 0.5 | 160 | 16 |
| 11 | TEOS | Al(OH)₃ | — | 17 | — | 4 | 0.5 | 0.5 | 0 | 0.5 | 160 | 9 |
| 12 | CBV760 | CBV760 | H₃BO₃ | 30 | 20 | 30 | 0.15 | 0.3 | 0.15 | — | 170 | 12 |
| | | | | | | | | | (K) | | | |
| 13 | CBV760 | CBV760 | H₃BO₃ | 30 | 33 | 30 | 0.15 | 0.3 | 0.15 | — | 170 | 12 |
| | | | | | | | | | (K) | | | |
| | Si | Al | B | Si/ | Si/ | H₂O/ | SDA/ | OH/ | | | T | T |
| Ex. | Source | Source | Source | Al | B | Si | Si | Si | M/Si | F/Si | (° C.) | (days) |
| 2 | CBV720 | CBV720 | — | 15 | — | 25 | 0.15 | 0.3 | 0.15 | — | 160 | 10 |
| | | | | | | | | | (Na) | | | |
| 3 | Cabosil | CBV500 | — | 16 | — | 30 | 0.15 | 0.3 | 0.15 | — | 160 | 18 |
| | M5 | CBV500 | | | | | | | (Na) | | | |
| 4 | Cabosil | CBV500 | — | 16 | — | 30 | 0.2 | 0.3 | 0.1 | — | 160 | 18 |
| | M5 | | | | | | | | (Na) | | | |
| 5 | Ludox | NaAlO₂ | — | 25 | — | 25 | 0.15 | 0.25 | 0.1 | — | 160 | 18 |
| | | | | | | | | | (Na) | | | |
| 6 | Ludox | NaAlO₂ | — | 20 | — | 30 | 0.2 | 0.3 | 0.1 | — | 160 | 18 |
| | | | | | | | | | (Na) | | | |
| 7 | Ludox | Al(OH)₃ | — | 16 | — | 30 | 0.15 | 0.3 | 0.15 | — | 160 | 18 |
| | Ludox | | | | | | | | (K) | | | |
| 8 | Ludox | Al(OH)₃ | — | 15 | — | 25 | 0.15 | 0.3 | 0.15 | — | 170 | 10 |
| | | | | | | | | | (K) | | | |
| 9 | Ludox | Al(OH)₃ | — | 10 | — | 25 | 0.15 | 0.3 | 0.15 | — | 170 | 10 |
| | | | | | | | | | (K) | | | |
| 10 | TEOS | Al(OH)₃ | — | 33 | — | 4 | 0.5 | 0.5 | 0 | 0.5 | 160 | 16 |
| 11 | TEOS | Al(OH)₃ | — | 17 | — | 4 | 0.5 | 0.5 | 0 | 0.5 | 160 | 9 |
| 12 | CBV760 | CBV760 | H₃BO₃ | 30 | 20 | 30 | 0.15 | 0.3 | 0.15 | — | 170 | 12 |
| | | | | | | | | | (K) | | | |
| 13 | CBV760 | CBV760 | H₃BO₃ | 30 | 33 | 30 | 0.15 | 0.3 | 0.15 | — | 170 | 12 |
| | | | | | | | | | (K) | | | |
| | Si | Al | B | Si/ | Si/ | H₂O/ | SDA/ | OH/ | | | T | T |
| Ex. | Source | Source | Source | Al | B | Si | Si | Si | M/Si | F/Si | (° C.) | (days) |
| 2 | CBV720 | CBV720 | — | 15 | — | 25 | 0.15 | 0.3 | 0.15 | — | 160 | 10 |
| | | | | | | | | | (Na | | | |
| 3 | Cabosil | CBV500 | — | 16 | — | 30 | 0.15 | 0.3 | 0.15 | — | 160 | 18 |
| | M5 | CBV500 | | | | | | | (Na) | | | |
| 4 | Cabosil | CBV500 | — | 16 | — | 30 | 0.2 | 0.3 | 0.1 | — | 160 | 18 |
| | M5 | | | | | | | | (Na) | | | |
| 5 | Ludox | NaAlO₂ | — | 25 | — | 25 | 0.15 | 0.25 | 0.1 | — | 160 | 18 |
| | | | | | | | | | (Na) | | | |
| 6 | Ludox | NaAlO₂ | — | 20 | — | 30 | 0.2 | 0.3 | 0.1 | — | 160 | 18 |
| | | | | | | | | | (Na) | | | |
| 7 | Ludox | Al(OH)₃ | — | 16 | — | 30 | 0.15 | 0.3 | 0.15 | — | 160 | 18 |
| | Ludox | | | | | | | | (K) | | | |
| 8 | Ludox | Al(OH)₃ | — | 15 | — | 25 | 0.15 | 0.3 | 0.15 | — | 170 | 10 |
| | | | | | | | | | (K) | | | |
| 9 | Ludox | Al(OH)₃ | — | 10 | — | 25 | 0.15 | 0.3 | 0.15 | — | 170 | 10 |
| | | | | | | | | | (K) | | | |
| 10 | TEOS | Al(OH)₃ | — | 33 | — | 4 | 0.5 | 0.5 | 0 | 0.5 | 160 | 16 |
| 11 | TEOS | Al(OH)₃ | — | 17 | — | 4 | 0.5 | 0.5 | 0 | 0.5 | 160 | 9 |
| 12 | CBV760 | CBV760 | H₃BO₃ | 30 | 20 | 30 | 0.15 | 0.3 | 0.15 | — | 170 | 12 |
| | | | | | | | | | (K) | | | |
| 13 | CBV760 | CBV760 | H₃BO₃ | 30 | 33 | 30 | 0.15 | 0.3 | 0.15 | — | 170 | 12 |
| | | | | | | | | | (K) | | | |

While the present invention has been described and illustrated with reference to particular embodiments, it will be appreciated by those of ordinary skill in the art that the invention lends itself to many different alterations, modifications, and variations not specifically illustrated herein. It will also be apparent to those skilled in the art that when numerical lower limits and numerical upper limits are listed herein, ranges from any lower limit to any upper limit are contemplated. Also, all numerical values within the detailed description herein are modified by “about” the indicated value, and take into account experimental error and variations that would be expected by a person having ordinary skill in the art.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

Additionally or alternately, the invention relates to:

Embodiment 1: A method of making a molecular sieve of CON framework type, comprising:
(a) preparing a synthesis mixture comprising water, a source of silica, a source of alumina, a structure directing agent (Q), a mineralizer, and optionally a source of alkali and/or alkaline earth metal element (M), wherein the mineralizer is selected from the group consisting of hydroxide ions (OH), fluoride ions (F), and mixtures thereof, and wherein the structure directing agent (Q) comprises a 1,2,3,4,6,7,8,9-octahydropyridazino[1,2-a]indazol-10-ium cation of Formula 1:

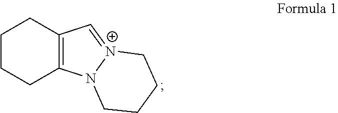 [SMILES: c1c2c(n3[n+]1CCCC3)CCCC2]

(b) heating said synthesis mixture under crystallization conditions including a temperature of from 100° C. to 200° C. for a time sufficient to form crystals of said molecular sieve; and
(c) recovering at least a portion of the molecular sieve from step (b).

Embodiment 2: The method of embodiment 1, wherein the structure directing agent (Q) is in the form of a halide, hydroxide or nitrate, preferably wherein the structure directing agent (Q) is its hydroxide form.

Embodiment 3: The method of embodiment 1 or 2, wherein the mineralizer comprises hydroxide ions (OH).

Embodiment 4: The method of embodiment 3, wherein the source of hydroxide ions comprises at least one of the structure directing agent (Q) in its hydroxide form, sodium hydroxide, potassium hydroxide, lithium hydroxide, and ammonium hydroxide, preferably the structure directing agent (Q) in its hydroxide form, sodium hydroxide, and/or potassium hydroxide.

Embodiment 5: The method of any one of the preceding embodiments, wherein the mineralizer comprises fluoride ions (F).

Embodiment 6: The method of embodiment 5, wherein the source of fluoride ions comprises at least one of HF, NH₄F, and NH₄HF₂, preferably HF.

Embodiment 7: The method of any one of the preceding embodiments, wherein the synthesis mixture has the following composition in terms of molar ratios:

| Molar ratios | Typical range | Preferred range | More preferred range |
|---|---|---|---|
| Si/Al | 5-100 | 10-50 | 10-35 |
| Q/Si | 0.01-1.0 | 0.05-0.8 | 0.1-0.5 |
| OH and/or F/Si | 0.05-1.5 | 0.1-1.0 | 0.2-1.0 |
| M/Si | 0-1.0 | 0.01-0.5 (if M present) | 0.05-0.3 (if M present) |
| H₂O/Si | 1-100 | 4-80 | 4-50 |

Embodiment 8: The method of any one of the preceding embodiments, wherein the synthesis mixture further comprises at least one source of boron oxide.

Embodiment 9: The method of embodiment 8, wherein boron is present in the synthesis mixture in a Si/B molar ratio of from 5 to 100, preferably from 10 to 50, more preferably from 10 to 35.

Embodiment 10: The method of any one of the preceding embodiments, further comprising treating the molecular sieve recovered in step (c) to remove at least part of the structure directing agent (Q).

Embodiment 11: A molecular sieve having at least one 1,2,3,4,6,7,8,9-octahydropyridazino[1,2-a]indazol-10-ium cation of Formula 1 within its pore structure.

Embodiment 12: The molecular sieve of embodiment 10, wherein the molecular sieve is of CON framework type.

Embodiment 13: The molecular sieve of embodiment 10 or 11, wherein the molecular sieve is of following Formula 2:

(q)Q:(m)Al₂O₃:(n)B₂O₃:SiO₂ (Formula 2),

wherein 0<q≤1.0, 0.005<m≤0.1, O≤n≤0.1, and Q is a 1,2,3,4,6,7,8,9-octahydropyridazino[1,2-a]indazol-10-ium cation of Formula 1.

Embodiment 14: The molecular sieve of any one of embodiments 10 to 13, obtainable by the method of any one of embodiments 1 to 9.

1. A method of making a molecular sieve of CON framework type, comprising:
(a) preparing a synthesis mixture comprising water, a source of silica, a source of alumina, a structure directing agent (Q), a mineralizer, and optionally a source of alkali and/or alkaline earth metal element (M),
wherein the mineralizer is selected from the group consisting of hydroxide ions (OH), fluoride ions (F), and mixtures thereof, and
wherein the structure directing agent (Q) comprises a 1,2,3,4,6,7,8,9-octahydropyridazino[1,2-a]indazol-10-ium cation of Formula 1: 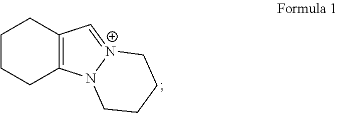 [SMILES: c1c2c(n3[n+]1CCCC3)CCCC2]
(b) heating said synthesis mixture under crystallization conditions including a temperature of from 100° C. to 200° C. for a time sufficient to form crystals of said molecular sieve; and
(c) recovering at least a portion of the molecular sieve from step (b).

2. The method of claim 1, wherein the structure directing agent (Q) is in the form of a halide, hydroxide or nitrate, preferably wherein the structure directing agent (Q) is its hydroxide form.

3. The method of claim 1, wherein the mineralizer comprises hydroxide ions (OH).

4. The method of claim 3, wherein the source of hydroxide ions comprises at least one of the structure directing agent (Q) in its hydroxide form, sodium hydroxide, potassium hydroxide, lithium hydroxide, and ammonium hydroxide, preferably the structure directing agent (Q) in its hydroxide form, sodium hydroxide, and/or potassium hydroxide.

5. The method of claim 1, wherein the mineralizer comprises fluoride ions (F).

6. The method of claim 5, wherein the source of fluoride ions comprises at least one of HF, NH₄F, and NH₄HF₂.

7. The method of claim 5, wherein the source of fluoride ions comprises HF.

8. The method of claim 1, wherein the synthesis mixture has the following composition in terms of molar ratios:

| Molar ratios | Range |
|---|---|
| Si/A1 | 5-100 |
| Q/Si | 0.01-1.0 |
| OH and/or F/Si | 0.05-1.5 |
| M/Si | 0-1.0 |
| H₂O/Si | 1-100 |

9. The method of claim 1, wherein the synthesis mixture has the following composition in terms of molar ratios:

| Molar ratios | Range |
|---|---|
| Si/Al | 10-50 |
| Q/Si | 0.05-0.8 |
| OH and/or F/Si | 0.1-1.0 |
| M/Si | 0.01-0.5 (if M present) |
| H₂O/Si | 4-80 |

10. The method of claim 1, wherein the synthesis mixture has the following composition in terms of molar ratios:

| Molar ratios | Range |
|---|---|
| Si/Al | 10-35 |
| Q/Si | 0.1-0.5 |
| OH and/or F/Si | 0.2-1.0 |
| M/Si | 0.05-0.3 (if M present) |
| H₂O/Si | 4-50 |

11. The method of claim 1, wherein the synthesis mixture further comprises at least one source of boron oxide.

12. The method of claim 11, wherein boron is present in the synthesis mixture in a Si/B molar ratio of from 5 to 100.

13. The method of claim 11, wherein boron is present in the synthesis mixture in a Si/B molar ratio of from 10 to 35.

14. The method of claim 1, further comprising treating the molecular sieve recovered in step (c) to remove at least part of the structure directing agent (Q).

15. A molecular sieve having at least one 1,2,3,4,6,7,8,9-octahydropyridazino[1,2-a]indazol-10-ium cation of Formula 1 within its pore structure

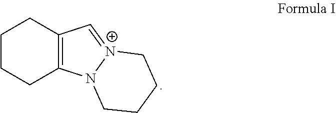 [SMILES: c1c2c(n3[n+]1CCCC3)CCCC2]

16. The molecular sieve of claim 15, wherein the molecular sieve is of CON framework type.

17. The molecular sieve of claim 15, wherein the molecular sieve is of following Formula 2:
(q)Q:(m)Al₂O₃:(n)B₂O₃:SiO₂ (Formula 2),
wherein 0<q≤1.0, 0.005<m≤0.1, O≤n≤0.1, and Q is a 1,2,3,4,6,7,8,9-octahydropyridazino[1,2-a]indazol-10-ium cation of Formula 1.

18. A molecular sieve of CON framework type made according to the method of claim 1.
